(19) United States
(12) Patent Application Publication
(10) Pub. No.: US 2026/0105710 A1
(43) Pub. Date: Apr. 16, 2026

(54) Colorization For Virtual Objects

(71) Applicant: Meta Platforms Technologies, LLC, Menlo Park, CA (US)

(72) Inventors: Marek VENTUR, London (GB); Mary XU, Redmond, WA (US); Ting-Yu CHEN, Beaverton, OR (US); Christopher HARVEY, Spanish Fork, UT (US); Richard Michael THOMSON, Southam (GB); Graham RUTLEDGE, Redwood City, CA (US)

(21) Appl. No.: 19/324,509

(22) Filed: Sep. 10, 2025

Related U.S. Application Data
(60) Provisional application No. 63/707,404, filed on Oct. 15, 2024.

(51) Int. Cl. G06T 19/20; G06F 3/01; G06F 3/04845; G06F 3/0485

(52) U.S. Cl. CPC G06T 19/20; G06F 3/017; G06F 3/04845; G06F 3/0485

(57) ABSTRACT

The disclosed colorization system provides a wider, more continuous range of color options for virtual object colorization, supported by an intuitive user interface that simplifies user selection while maximizing customization possibilities. The colorization system provides continuous color ranges for virtual objects, using dynamically generated color ramps. In some implementations, the colorization systems provides two-dimensional (2D) color ramps that represent a continuous range of color options, that may be fully art-directed while also allowing for a wide range of color options than discrete options. The 2D color ramp can act as a source texture or gradient from which a near-infinite number of 1D color ramps can be dynamically derived based on user input.

### CROSS-REFERENCE TO RELATED APPLICATIONS

This application claims priority to U.S. Provisional Patent Application No. 63/707,404, titled “COLORIZATION FOR VIRTUAL OBJECTS,” ( filed Oct. 15, 2024, which is herein incorporated by reference in its entirety.

### TECHNICAL FIELD

The present disclosure generally relates to mixed reality, and more particularly to the customization and colorization of virtual objects within a mixed reality environment.

### BACKGROUND

Virtual objects in mixed reality are three-dimensional (3D) models that can be customized for a given user. At present, colorization is often accomplished by having certain textures in greyscale and applying a second ‘color ramp’ texture to them. These color ramps function as lookup tables, mapping greyscale values (e.g., from 0-255) to specific colors, which are then used to colorize the greyscale textures. As applied to user avatars, for example, these one-dimensional (1D) color ramps may be used to colorize features such as hair, skin, and eyes.

Because these ramps are typically authored individually, they only support a discrete and fixed set of colors. This limitation is particularly apparent for complex features where color is not uniform. For example, skin color ramps must account for the lighter and darker parts of a person's body, and a single eye “color” in reality comprises multiple distinct colors and tones. Having a continuous, nuanced range of colors cannot be simply solved by employing existing RGB color pickers or similar colorization options without providing users with an overwhelming number of choices that could be unappealing and/or overcomplicate the user interface.

Existing solutions to this problem are often built around single solid colors that are artificially restricted to a given range. They do not give designers the flexibility to craft rich, multi-toned color ranges in either hue, saturation, or brightness (or a combination of all of them). This results in a user experience that lacks the desired level of personalization and realism.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are included to provide further understanding and are incorporated in and constitute a part of this specification, illustrate disclosed implementations and together with the description serve to explain the principles of the disclosed implementations.

FIG. 1 is a diagram illustrating an example network architecture used to implement the colorization of virtual objects, according to some implementations.

FIG. 2 is a block diagram illustrating details of an example system for the colorization of virtual objects, according to some implementations.

FIG. 3A is a diagram illustrating an example mixed reality head-mounted display (HMD) in which implementations of the subject technology may be implemented.

FIG. 3B is a diagram illustrating an example mixed reality HMD system which includes a mixed reality HMD and a core processing component, according to some implementations.

FIG. 3C is a diagram illustrating example controllers that a user can hold to interact with the mixed reality environment presented by the HMDs of FIGS. 3A and 3B, according to some implementations.

FIG. 4 is a conceptual diagram illustrating an example of using a one-dimensional (1D) ramp for static colorization, according to some implementations.

FIG. 5 is a conceptual diagram illustrating an example of using a two-dimensional (2D) ramp for parameterized colorization, according to some implementations.

FIG. 6 is a conceptual diagram illustrating an example of designing parametric colors for a virtual avatar, according to some implementations.

FIG. 7 is a conceptual diagram illustrating an example conversion strategy for parametric skin color, according to some implementations.

FIGS. 8A, 8B, and 8C are conceptual diagrams illustrating an example conversion strategy for parametric eye color, according to some implementations.

FIG. 9 is a conceptual diagram illustrating an example conversion strategy for parametric hair color, according to some implementations.

FIG. 10 is a conceptual diagram illustrating an example conversion strategy for parametric brow color, according to some implementations.

FIG. 11 is a conceptual diagram illustrating an example of parametric hair color selection for a brown shade, according to some implementations.

FIG. 12 is a conceptual diagram illustrating an example of parametric hair color selection for a black shade, according to some implementations.

FIG. 13 is a block diagram illustrating an exemplary computer system with which aspects of the subject technology can be implemented, according to some implementations.

FIG. 14 is a flow diagram illustrating a process used in some implementations for colorizing a virtual object in an extended reality environment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the implementations of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some implementations, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

There is a need for a system and method that provides a wider, more continuous range of color options for virtual object colorization, supported by an intuitive user interface that simplifies user selection while maximizing customization possibilities. Implementations of the present disclosure address this and related problems by providing continuous color ranges for virtual objects, using dynamically generated color ramps, and providing an intuitive user interface for users to select colors therefrom. Specifically, some implementations provide a two-dimensional (2D) color ramp that represents a continuous range of color options, that may be fully art-directed while also allowing for a much wider range of color options than discrete options. This 2D ramp acts as a source texture or gradient from which a near-infinite number of 1D color ramps can be dynamically derived based on user input.

The virtual objects that may be colorized may include, but are not limited to, user avatars, with customizable hair, eyes, skin, etc. Virtual objects may further include, but are not limited to, clothing, accessories (glasses, props, objects), weapons (gun, swords, etc.), vehicles, animals, tools, and more. The techniques described herein can be applied to any 3D model that utilizes texture mapping for its surface appearance.

In some implementations, the 2D ramps are similar to existing color ramps stacked up on top of each other to an arbitrary height. This may be accomplished is some implementations by using a 2D image, which allows for a technically discrete set of options. In some implementations, the 2D ramp image is explicitly described using gradients. By slicing these 2D ramp images horizontally at a given height, continuously changing one-dimensional (1D) color ramps are derived that may be applied to avatar grey scale textures. For example, a 2D ramp can be implemented as a 2D texture map where the horizontal axis corresponds to the greyscale input value and the vertical axis corresponds to a parametric input value provided by the user.

In some implementations, 2D ramps may also be used to provide a source for user visible representations of the ramps in the form of discrete buttons or color sliders. This may be done, for example, by slicing the 2D ramp vertically at a predefined position that has been deemed representative. For complex (multi-toned) color ramps, more than one vertical slice may be used to give the user an idea of what contrasting colors are involved. These vertical slices can be used to generate the icons or swatches presented to the user for their initial selection.

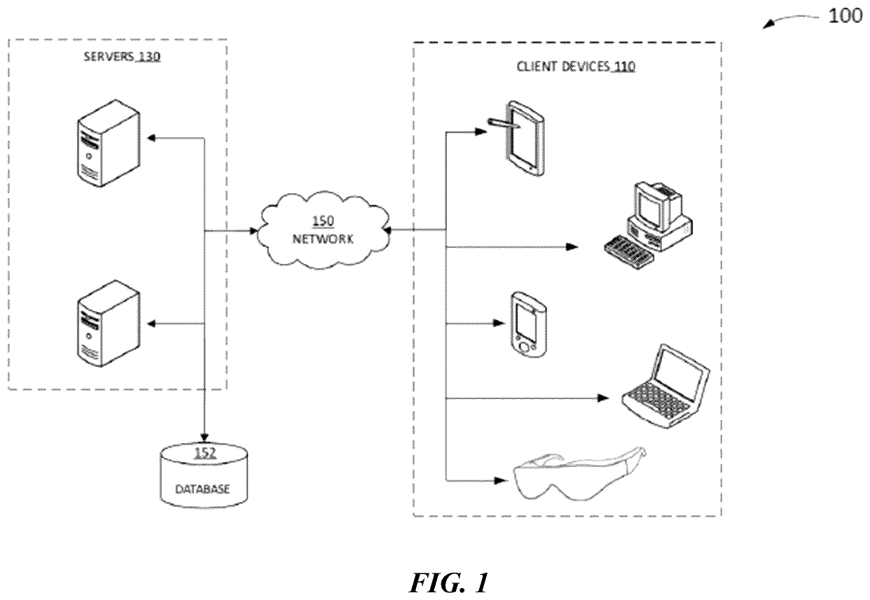

FIG. 1 illustrates a network architecture 100 used to implement colorization of virtual objects, according to some implementations. The network architecture 100 may include one or more client devices 110 and servers 130, communicatively coupled via a network 150 with each other and to at least one database 152. Database 152 may store data and files associated with the servers 130 and/or the client devices 110, such as 3D models, greyscale textures, 2D color ramp assets, and user profiles. In some implementations, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

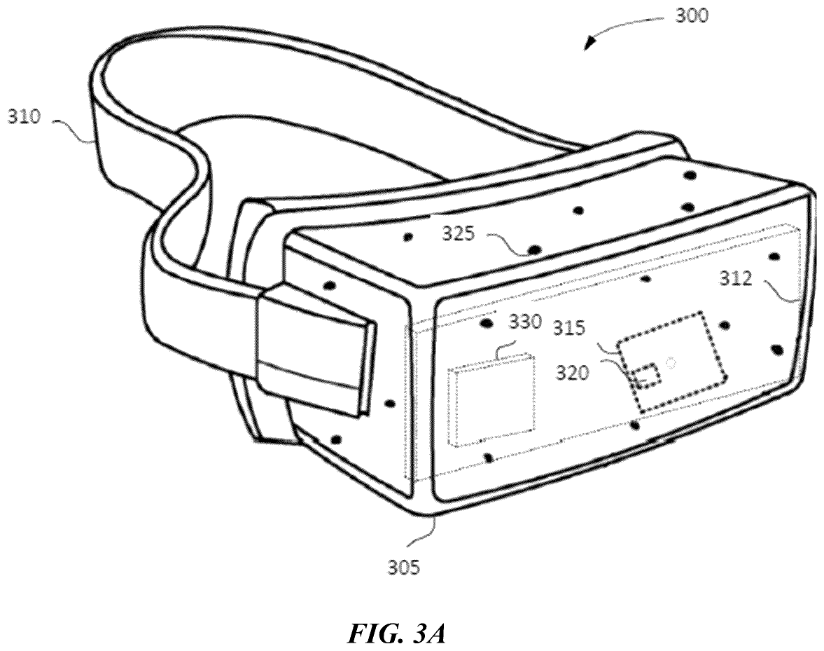

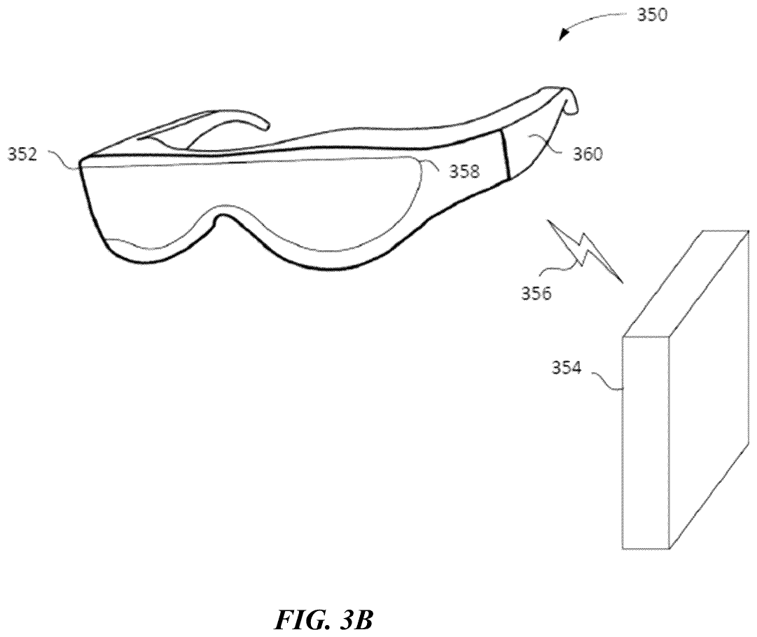

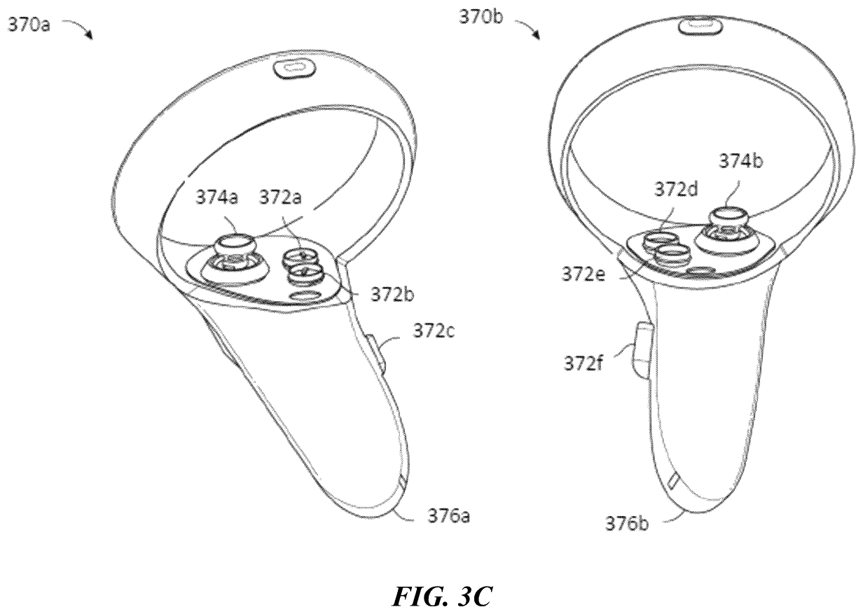

Client devices 110 may include, but are not limited to, laptop computers, desktop computers, and mobile devices such as smart phones, tablets, televisions, wearable devices, head-mounted devices (as shown in FIGS. 3A-3B), display devices, and the like.

In some implementations, the servers 130 may be a cloud server or a group of cloud servers. In other implementations, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some implementations, the servers 130 may include the client devices 110 as well, such that they are peers.

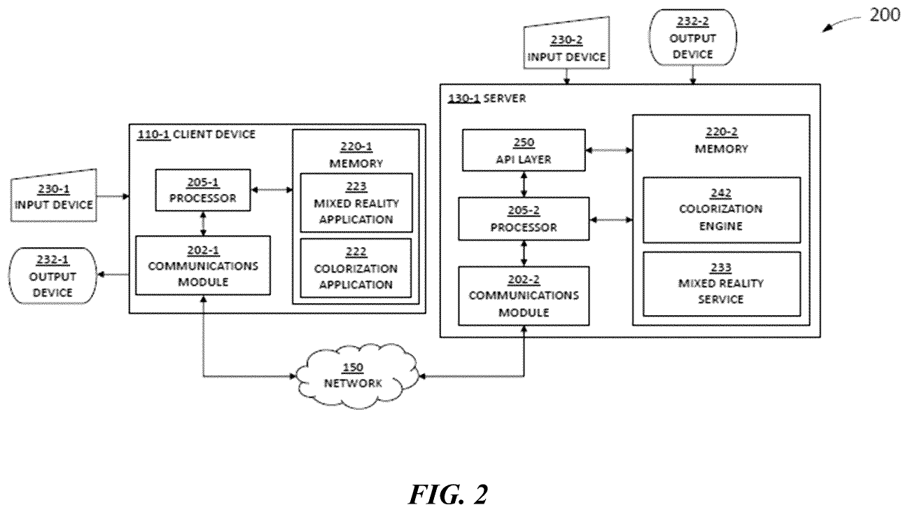

FIG. 2 is a block diagram illustrating details of a system 200 for colorization of virtual objects, according to some implementations. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with implementations of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller (e.g., as shown in FIG. 3C), a keyboard, a pointer, a stylus, a touchscreen, a microphone, voice recognition software, a joystick, a virtual joystick, a touch-screen display, and the like. In some implementations, the input devices 230 may include cameras, microphones, sensors, and the like. In some implementations, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device or an HMD display), a speaker, an alarm, and the like. A user may interact with client device 110-1 and/or server 130-1 via the input devices 230 and the output devices 232.

Memory 220-1 on the client device may further include a colorization application 222, configured to execute on client device 110-1 and couple with input device 230-1 and output device 232-1. The application 222 may be downloaded by the user from server 130-1, and/or may be hosted by server 130-1. The colorization application 222 may include specific instructions which, when executed by processor 205-1, cause operations to be performed consistent with implementations of the present disclosure. In some implementations, the colorization application 222 runs on an operating system (OS) installed in client device 110-1. In some implementations, colorization application 222 may run within a web browser. In some implementations, the processor 205-1 is configured to control a graphical user interface (GUI) (e.g., spanning at least a portion of input devices 230 and output devices 232) for the user of client device 110-1 to access the server 130-1.

In some implementations, memory 220-2 on the server includes a colorization application engine 242. The colorization application engine 242 may be configured to manage and serve the assets required for colorization, such as the 2D color ramp textures. The colorization application engine 242 may share or provide features and resources with the client device 110-1, including data, libraries, and/or applications retrieved with colorization application engine 242 (e.g., colorization application 222). The user may access the functionality of the colorization application engine 242 through the client-side colorization application 222. The colorization application 222 may be installed in client device 110-1 by the colorization application engine 242 and/or may execute scripts, routines, programs, applications, and the like provided by the colorization application engine 242.

Memory 220-1 may further include a mixed reality application 223, configured to execute in client device 110-1. The mixed reality application 223 may communicate with a mixed reality service 233 in memory 220-2 to provide a mixed reality experience and/or environment to the user of client device 110-1. The mixed reality application 223 may communicate with mixed reality service 233 through an API layer 250, for example. The colorization application 222 may function as a module within the larger mixed reality application 223, providing the user interface and logic for avatar or object customization.

FIGS. 3A-3B are diagrams illustrating virtual and mixed reality headsets, according to certain aspects of the present disclosure.

FIG. 3A is a diagram of a virtual reality head-mounted display (HMD) 300. As a non-limiting example, the HMD 300 may be one or more of the client devices 110 (e.g., client device 110-1). The HMD 300 includes a front rigid body 305 and a band 310 for securing the device to a user's head. The front rigid body 305 includes one or more electronic display elements such as an electronic display 312, an inertial motion unit (IMU) 315, one or more position sensors 320, locators 325, and one or more compute units 330. The position sensors 320, the IMU 315, and compute units 330 may be internal to the HMD 300 and may not be visible to the user. The locators 325 may be, for example, infrared LEDs or cameras used for positional tracking. In various implementations, the IMU 315, position sensors 320, and locators 325 may track movement and location of the HMD 300 in the real world and in a virtual environment in three degrees of freedom (3DoF), six degrees of freedom (6DoF), etc. For example, the locators 325 may emit infrared light beams which create light points on real objects around the HMD 300. As another example, the IMU 315 may include, e.g., one or more accelerometers, gyroscopes, magnetometers, other non-camera-based position, force, or orientation sensors, or combinations thereof. One or more cameras (not shown) integrated with the HMD 300 may detect the light points, such as for a computer vision algorithm or module. The compute units 330 in the HMD 300 may use the detected light points to extrapolate position and movement of the HMD 300 as well as to identify the shape and position of the real objects surrounding the HMD 300.

The electronic display 312 may be integrated with the front rigid body 305 and may provide image light to a user as dictated by the compute units 330. In various implementations, the electronic display 312 may be a single electronic display or multiple electronic displays (e.g., a display for each user eye). Examples of the electronic display 312 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 312 may be coupled with an audio component, such as sending and receiving output from various other users of the XR environment wearing their own XR headsets, for example. The audio component may be configured to host multiple audio channels, sources, or modes.

In some implementations, the HMD 300 may be coupled to a core processing component such as a personal computer (PC) (not shown) and/or one or more external sensors (not shown). The external sensors may monitor the HMD 300 (e.g., via light emitted from the locators 325) which the PC may use, in combination with output from the IMU 315 and position sensors 320, to determine the location and movement of the HMD 300.

FIG. 3B is a diagram of a mixed reality HMD system 350 which includes a mixed reality HMD 352 and a core processing component 354. The mixed reality HMD 352 includes a pass-through display 358 and a frame 360, resembling a pair of glasses. The mixed reality HMD 352 and the core processing component 354 may communicate via a wireless connection (e.g., a 60 GHz link) as indicated by the link 356. In other implementations, the mixed reality HMD system 350 includes a headset only, without an external compute device or includes other wired or wireless connections between the mixed reality HMD 352 and the core processing component 354. The mixed reality HMD 352 includes a pass-through display 358 and a frame 360. The frame 360 may house various electronic components (not shown) such as light projectors (e.g., LASERs, LEDs, etc.), cameras, eye-tracking sensors, MEMS components, networking components, etc. The frame 360 or another part of the mixed reality HMD 352 may include an audio electronic component such as a speaker (not shown in FIG. 3B). The speaker may output audio from various audio sources, such as a phone call, VolP session, or other audio channel. The electronic components may be configured to implement audio switching based on user gaming or XR interactions.

The projectors may be coupled to the pass-through display 358, e.g., via optical elements, to display media to a user. The optical elements may include one or more waveguide assemblies, reflectors, lenses, mirrors, collimators, gratings, etc., for directing light from the projectors to a user's eye. Image data may be transmitted from the core processing component 354 via link 356 to HMD 352. Controllers in the HMD 352 may convert the image data into light pulses from the projectors, which may be transmitted via the optical elements as output light to the user's eye. The output light from the projectors may mix with light that passes through the display 358 from the real world, allowing the output light to present virtual objects that appear as if they exist in the real world.

Similarly to the HMD 300, the HMD system 350 may also include motion and position tracking units, cameras, light sources, etc., which allow the HMD system 350 to, e.g., track itself in 3DoF or 6DoF, track portions of the user (e.g., hands, feet, head, or other body parts), map virtual objects to appear as stationary as the HMD 352 moves, and have virtual objects react to gestures and other real-world objects. For example, the HMD system 350 may track the motion and position of the user's wrist movements as input gestures for performing XR navigation. As an example, the HMD system 350 may include a coordinate system to track the relative positions of various XR objects and elements in a shared artificial reality environment.

FIG. 3C illustrates controllers 370a-370b, which, in some implementations, a user may hold in one or both hands to interact with an artificial reality environment presented by the HMD 300 and/or HMD 350. As a non-limiting example, one or more of the mixed reality controllers 370a-370b may be one or more of the client devices 110 (e.g., client device 110-1). The controllers 370a-370b may be in communication with an HMD (including but not limited to HMD 300 and/or mixed reality HMD 352), either directly or via an external device (e.g., core processing component 354). The controllers 370a-370b may have their own IMU units, cameras, position sensors, and/or light emitters. The HMD 300 or 350, external sensors, or sensors in the controllers may be used to determine the controller positions and/or orientations (e.g., to track the controllers in 3DoF or 6DoF). The compute units 330 in the HMD 300 or the core processing component 354 may use this tracking, in combination with IMU and position output, to monitor hand positions and motions of the user. For example, the compute units 330 may use the monitored hand positions to implement navigation and scrolling via the hand positions and motions of the user, such as to enable a high fiving motion in XR.

The controllers 370a-370b may also include various buttons (e.g., buttons 372a-f) and/or joysticks (e.g., joysticks 374a-b), which a user may actuate to provide input and interact with objects. As discussed below, controllers 370a-370b may also have tips 376a and 376b, which, when in scribe controller mode, may be used as the tip of a writing implement in the artificial reality environment. In various implementations, the HMD 300 or 350 may also include additional subsystems, such as a hand tracking unit, an eye tracking unit, an audio system, various network components, etc., to monitor indications of user interactions and intentions. For example, in some implementations, instead of or in addition to controllers, one or more cameras included in the HMD 300 or 350, or from external cameras, may monitor the positions and poses of the user's hands to determine gestures and other hand and body motions. Such camera-based hand tracking may be referred to as computer vision, for example. Sensing subsystems of the HMD 300 or 350 may be used to define motion (e.g., user hand/wrist motion) along an axis (e.g., three different axes).

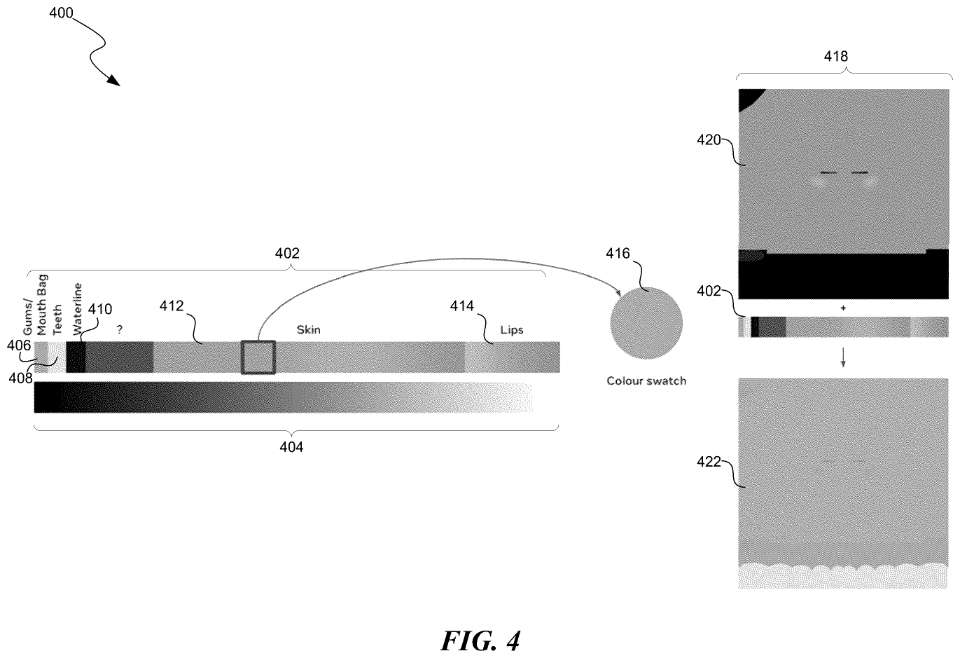

FIG. 4 illustrates an example 400 of using a 1D ramp 402 for static colorization, according to some implementations. In this example, all of the color choices are a 1D color ramp, where the pixel values vary along a single horizontal axis. Color ramps may have 256 pixels of color information. Each pixel along a ramp directly maps to a grey color (where black is 0 and white is 255) in element 404. As shown, color ramp 402 can include several sub-ramps that map to different parts of a texture (e.g., gums portion 406, teeth portion 408, waterline portion 410, skin portion 412, and lips portion 414). There may be a dominant or representative color on the ramp, represented as a color swatch 416, that can be used in a selection UI. The user may select the swatch to select the entire 1D ramp (from a selection of multiple available 1D ramps). The mapping of the selected 1D ramp 402 is then used (as shown in section 418) take the greyscale textures 420 and convert them to colorized textures 422, for a virtual object. This is how multiple distinct colorways may be achieved from a single greyscale texture.

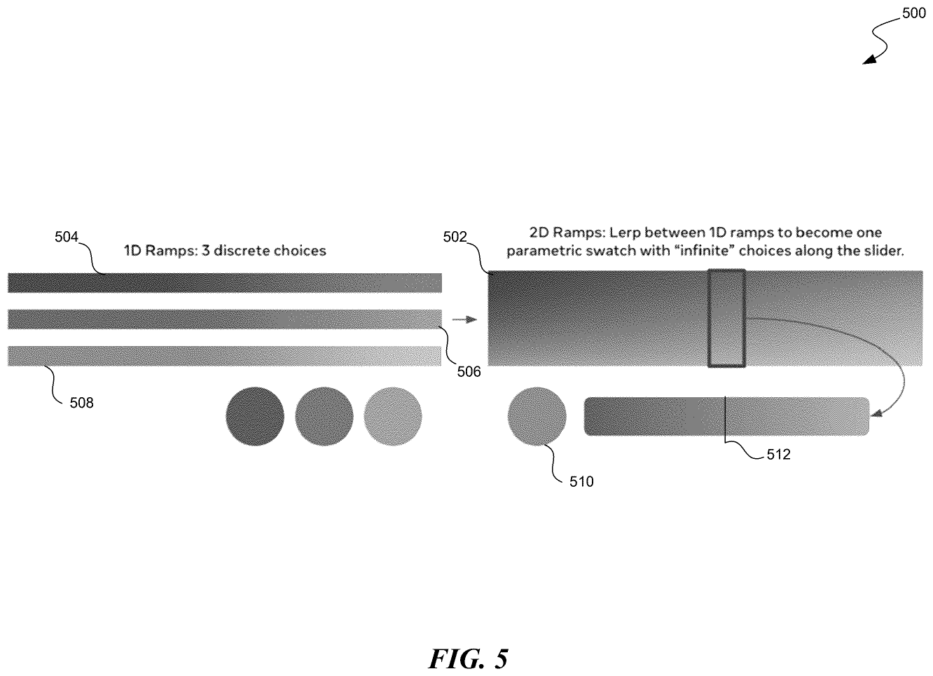

FIG. 5 illustrates an example 500 of using a 2D ramp 502 for parametrized colorization, according to some implementations. Color ramps may be extended with an additional axis to provide much more granular customization. 2D ramps may be considered as multiple 1D ramps (e.g., ramps 504, 506, and 508) stacked on top of each other. The 2D ramp 502 works the same way as a 1D ramp, but the user is prompted to provide an additional parameter, e.g., the vertical location along the 2D ramp, via a slider 512 to specify which “row” of the 2D ramp to use. The user data may be stored as a swatch (e.g., swatch 510) selection and a value (e.g., a float numeric type) to specify the selection along the slider 512. The slider 512 value may be used to perform a linear interpolation (“lerp”) operation to determine the vertical “row”value of the 2D ramp.

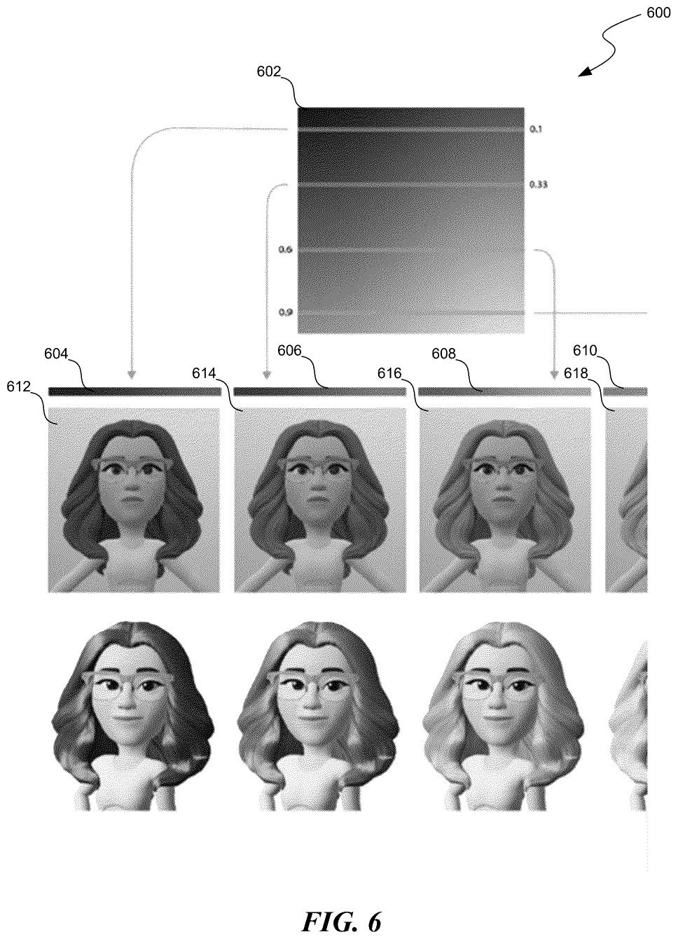

FIG. 6 illustrates an example 600 of designing parametric colors, according to some implementations. In example 600, the virtual object is a user avatar, with user-customizable categories of skin, eye, lip, and hair color. The eye color may include sub-categories of sclera, iris, and pupil colors. The hair color may include sub-categories of head, brow, and facial colors. As shown, a 2D ramp 602 with different vertical values (e.g., 0.1, 0.33, 0.6, 0.9) can be used to select various 1D ramps (604, 606, 608, and 610), with corresponding selected colors to generate a variety of avatar appearances 612, 614, 616, and 618 in corresponding color schemes.

One feature of parametric colorization is reduced confusion and clutter in the color selection user interface by eliminating highly similar choices and/or swatches. Another features is improved personalization by greatly increasing the possible colors. 2D ramps may be thoughtfully designed to achieve at least these features, providing a curated yet expansive set of aesthetic options.

Natural colors for all categories may be achieved using generic groupings. Fantastical or non-natural colors (e.g., blue skin, green hair) may require specialized groupings. Strategies of some implementations for converting static colors to parametric colors in each category are described below.

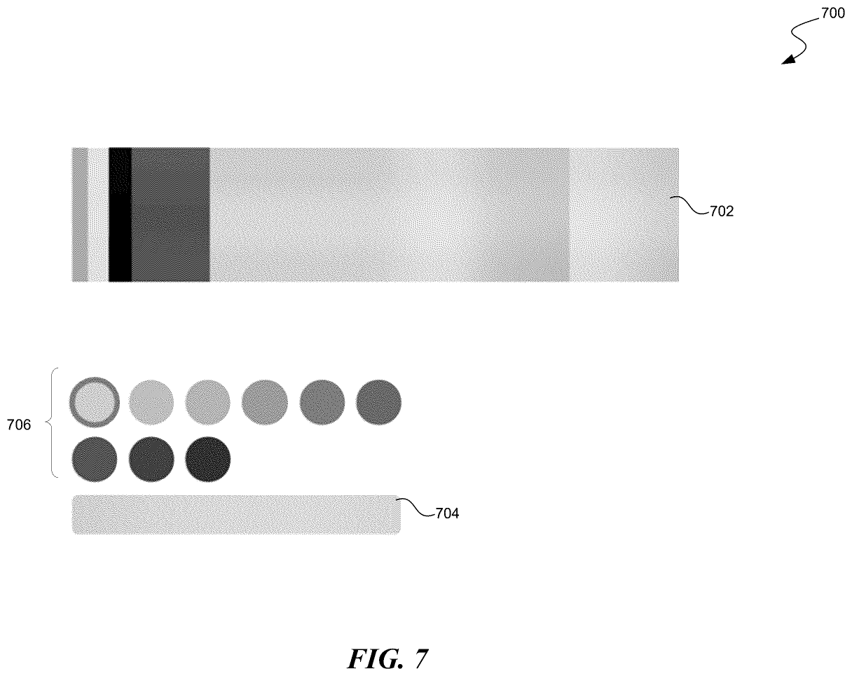

FIG. 7 illustrates an example 700 of a conversion strategy for parametric skin color, according to some implementations. Natural skin colors may be generically described with two axes: shades (light/dark) 702 and undertones 704 (warm, neutral, cool). An approach of some implementations is to use nine swatches 706 for shade, and a slider 704 for the undertone. The nine swatches may represent nine distinct base skin shades from light to dark. In some implementations, darker shades may be added for improved skin color representation, as well as fun or fantastical shades such as pink, green, blue, etc. The user's selection of a swatch 706 determines the base shade. The slider 704 then allows the user to adjust the undertone along a continuous spectrum. Thus, instead of selecting a shade and then one of three discrete options for undertone (resulting in 27 choices), the user now only needs to select from 9 shade choices 706 (shade, via swatch) and then specify the undertone via the slider 704, providing a more intuitive and granular control.

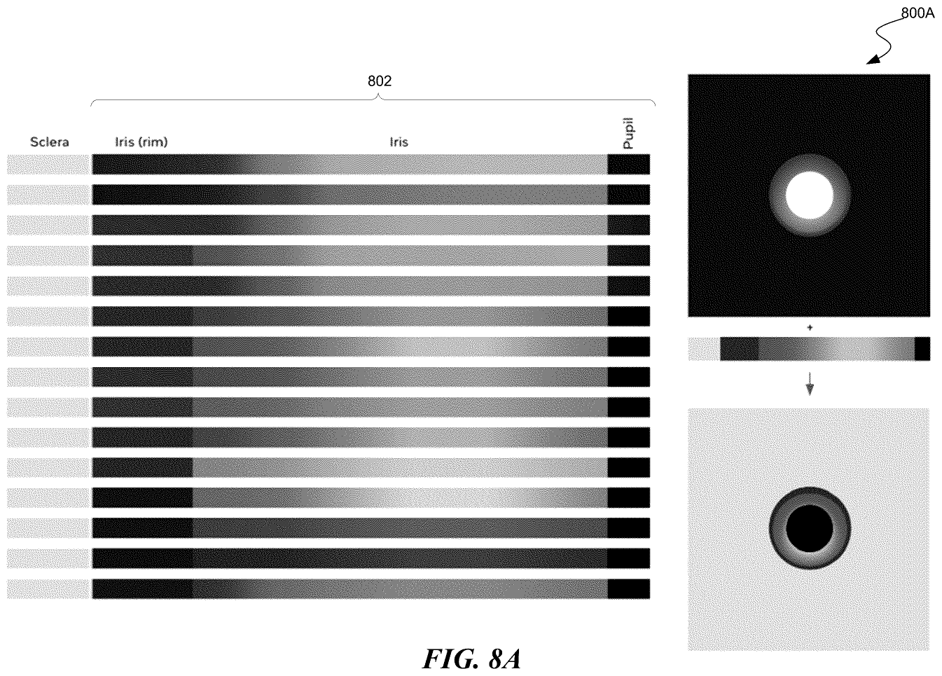

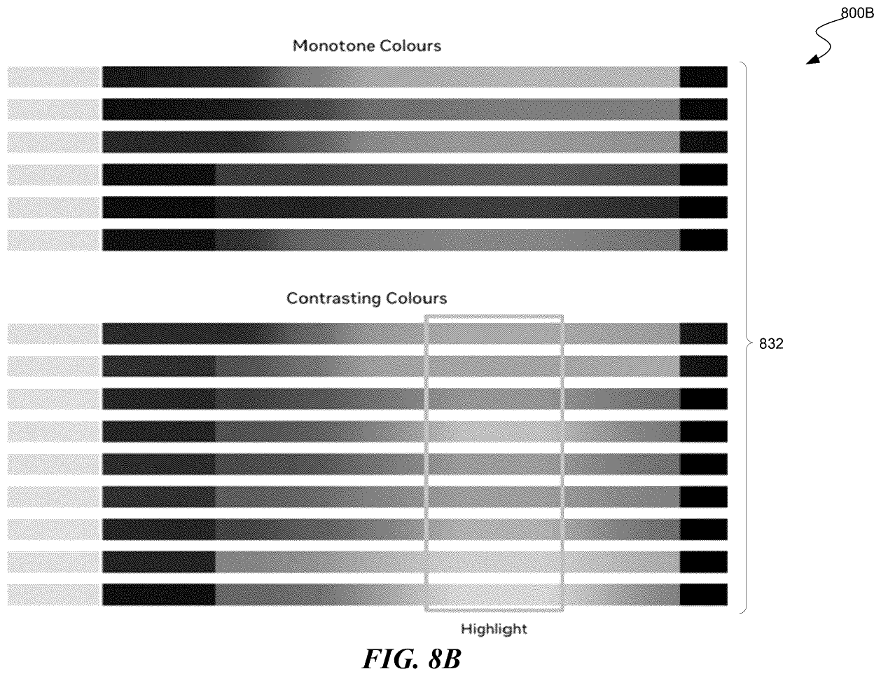

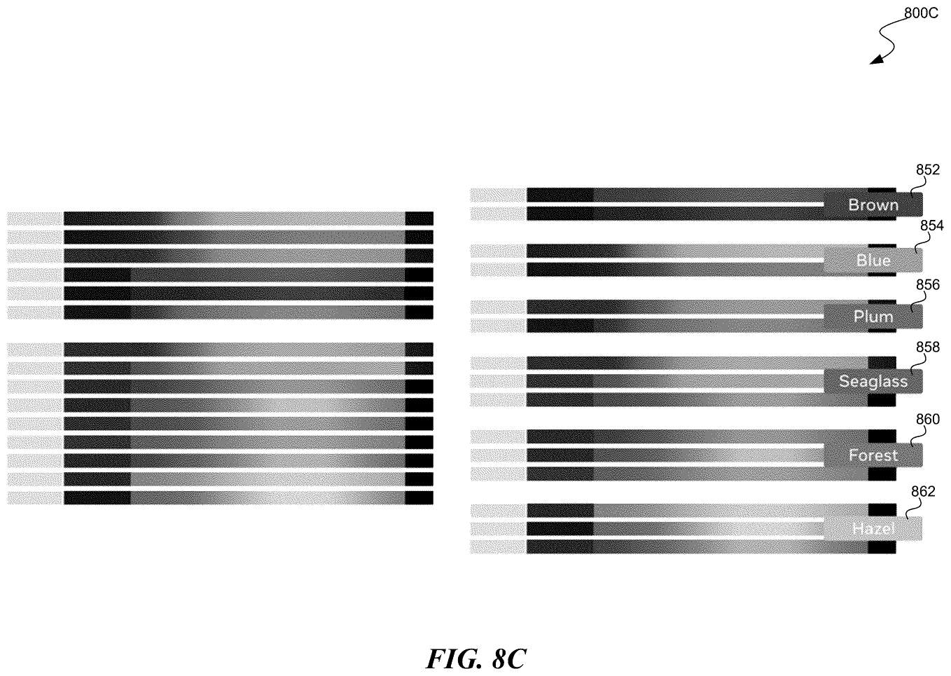

FIGS. 8A, 8B, and 8C illustrate an example 800A, 800B, and 800C of a conversion strategy for parametric eye color, according to some implementations. A 1D approach is shown in FIG. 8A, where fifteen different color choices are available, for different iris colors. Each 1D ramp 802 defines the color for the iris, the iris rim, the sclera, and the pupil. The rim of the iris and the iris itself are different but selected to be complementary on each 1D ramp.

FIG. 8B shows an example 800B of the use of 2D ramps 832 for eye color. Both natural and fantastical eye colors may be desired. There may also be two types of eye ramp styles, monotone (having a singular, primary hue) and contrasting (having a noticeably different highlight hue). An approach of some implementations is to naively combine choices that are similar in hue. As an example, FIG. 8C shows an example 800C with reduction from fifteen color choices to six, namely brown 852, blue 854, plum 856, sea glass 858, forest 860, and hazel 862. Each of these six categories can be represented by a 2D ramp, where sliders might control, for example, the intensity or position of a highlight, or the overall brightness.

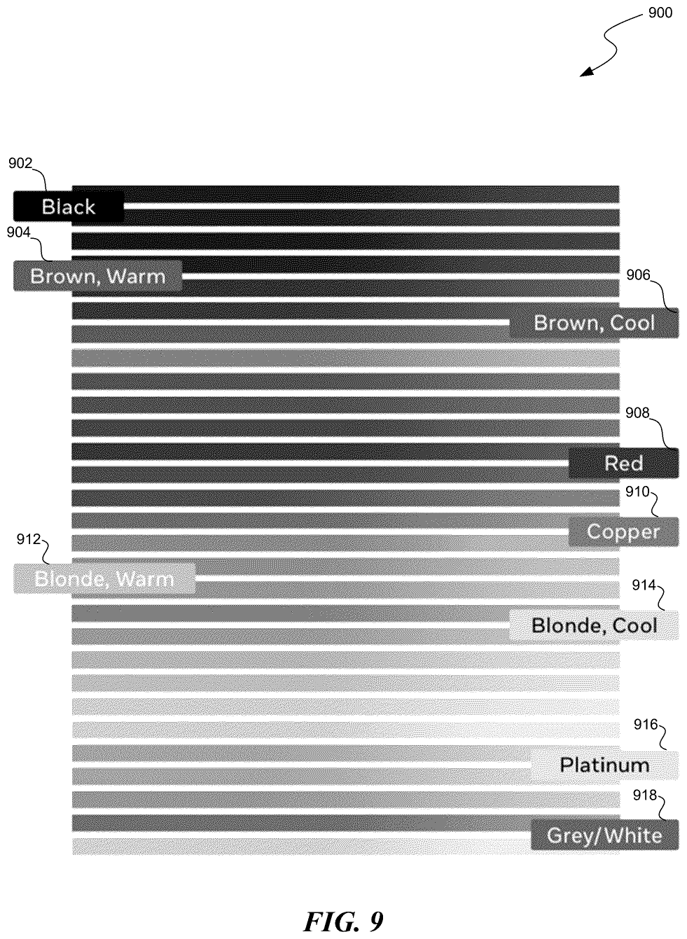

FIG. 9 illustrates an example 900 of a conversion strategy for parametric hair color, according to some implementations. There may be both natural and fantastical hair colors, and these may be addressed separately. An approach of some implementations is to combine similar choices, separate warm and cool tones to allow for smooth gradients, and add a slider for shade to adjust darkness and brightness. Black is a special case in some implementations, where the slider would adjust hue. As an example, twenty-eight natural choices may be reduced to nine, namely black 902, brown (warm) 904, brown (cool) 906, red 908, copper 910, blonde (warm) 912, blonde (cool) 914, platinum 916, and grey/white 918.

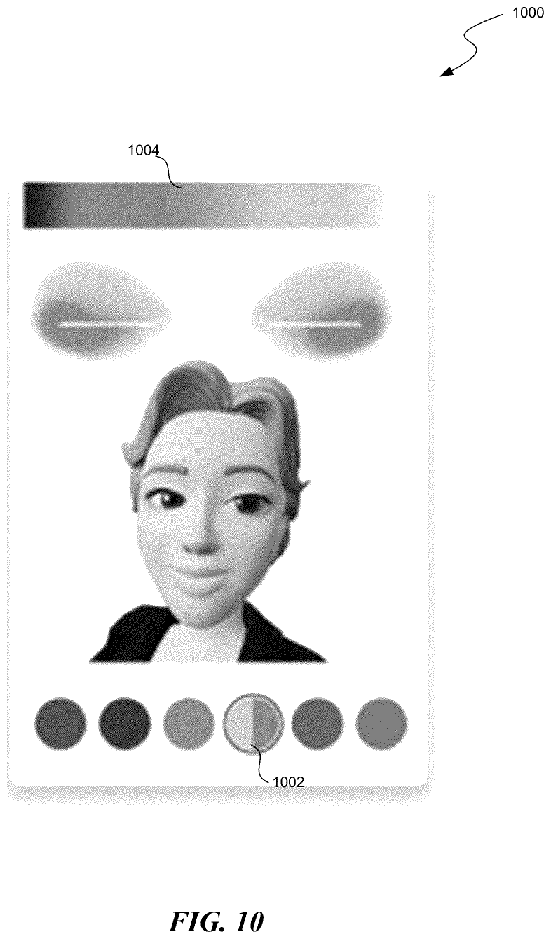

The selection of a swatch in some implementations is to select hue and lightness. The slider effect may be swatch dependent, to adjust lightness, color, hue, etc. FIG. 10 illustrates an example 1000 of a conversion strategy for parametric brow color, according to some implementations. For example, as shown in the parametric brow color strategy of FIG. 10, a user can select a primary color swatch (e.g., swatch 1002) and then use a slider 1004 to blend between different related colors or tones.

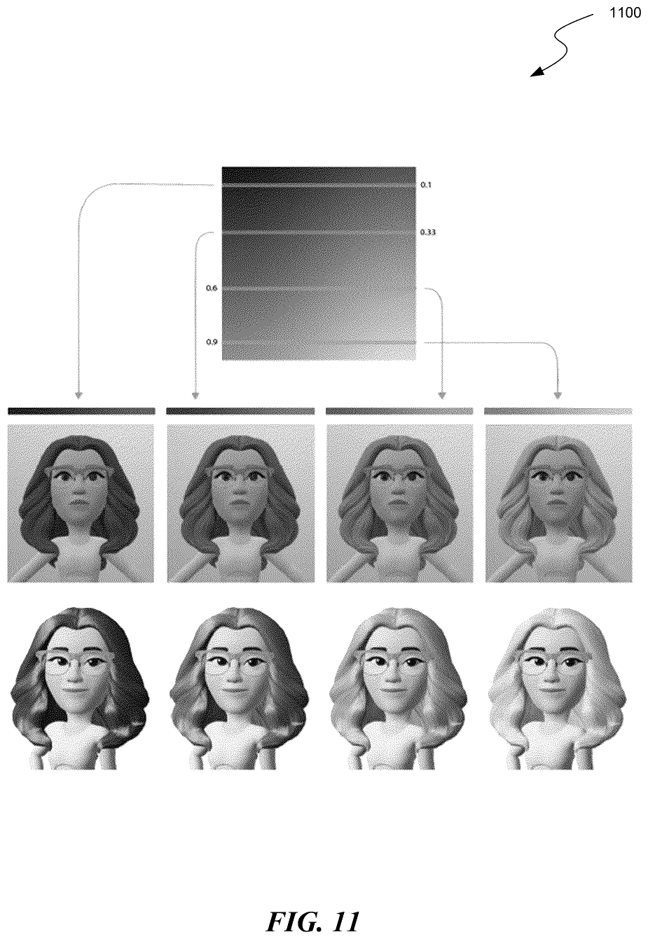

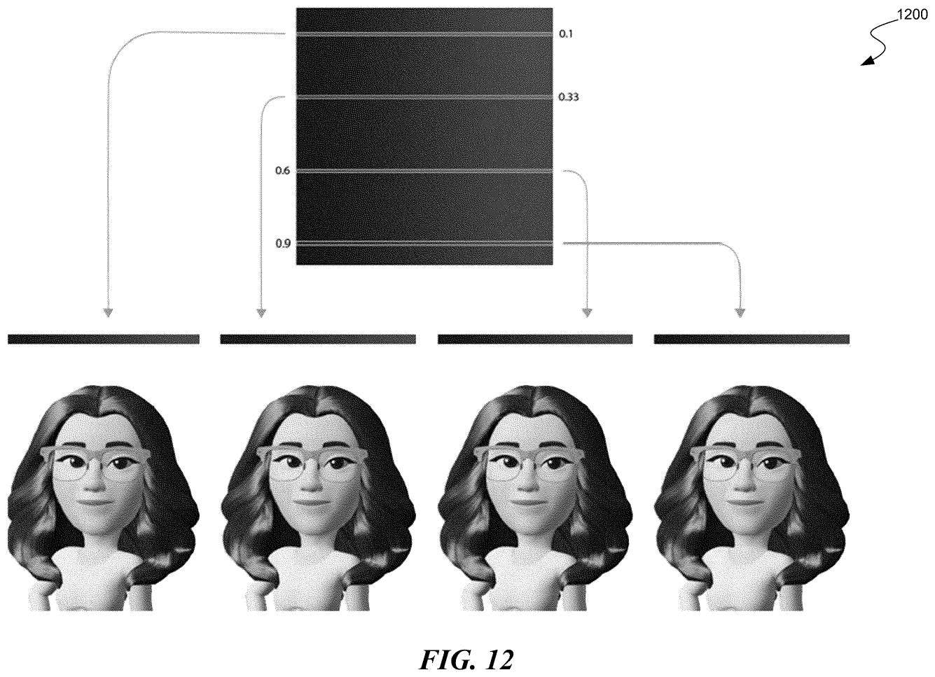

FIG. 11 illustrates an example 1100 of parametric hair color selection for a brown shade, according to some implementations. FIG. 12 illustrates an example 1200 of parametric hair color selection for a black shade, according to some implementations. In examples 1100 and 1200, a 2D ramp allows for continuous selection between different tones and brightness levels.

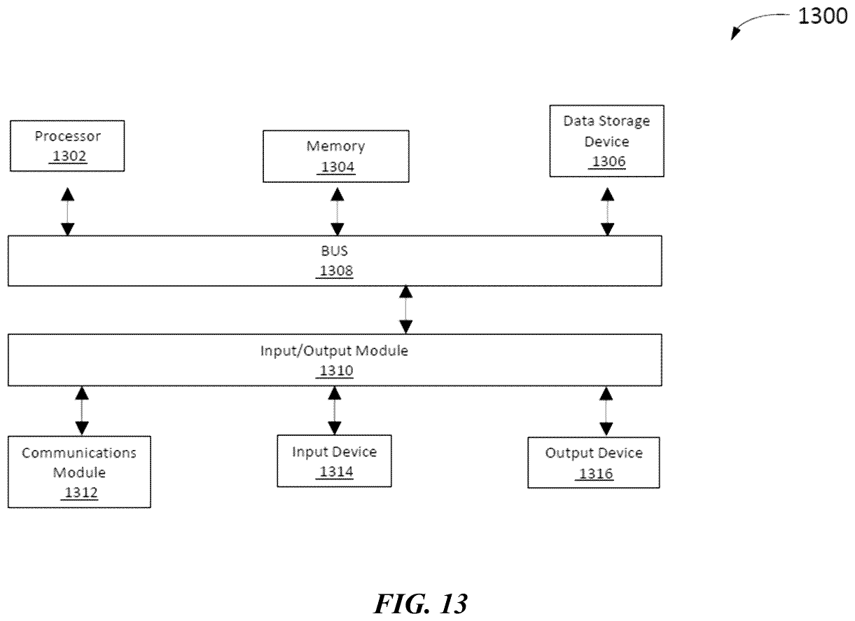

FIG. 13 is a block diagram illustrating an exemplary computer system 1300 with which aspects of the subject technology can be implemented. In certain aspects, the computer system 1300 may be implemented using hardware or a combination of software and hardware, either in a dedicated server, integrated into another entity, or distributed across multiple entities. As a non-limiting example, the computer system 1300 may be one or more of the servers 130 and/or the client devices 110.

Computer system 1300 includes a bus 1308 or other communication mechanism for communicating information, and a processor 1302 coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, e.g., code that constitutes processor firmware, a protocol stack, a database management system, an operating system, or a combination of one or more of them stored in an included memory 1304, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, i.e., one or more modules of computer program instructions encoded on a computer-readable medium for execution by, or to control the operation of, the computer system 1300, and according to any method well-known to those of skill in the art, including, but not limited to, computer languages such as data-oriented languages (e.g., SQL, dBase), system languages (e.g., C, Objective-C, C++, Assembly), architectural languages (e.g., Java,. NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled to bus 1308 for storing information and instructions. Computer system 1300 may be coupled via input/output module 1310 to various devices. The input/output module 1310 can be any input/output module. Exemplary input/output modules 1310 include data ports such as USB ports. The input/output module 1310 is configured to connect to a communications module 1312. Exemplary communications modules 1312 include networking interface cards, such as Ethernet cards and modems. In certain aspects, the input/output module 1310 is configured to connect to a plurality of devices, such as an input device 1314 and/or an output device 1316. Exemplary input devices 1314 include a keyboard and a pointing device, e.g., a mouse or a trackball, by which a user can provide input to the computer system 1300. Other kinds of input devices 1314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1316 include display devices such as an LCD (liquid crystal display) monitor, for displaying information to the user.

According to one aspect of the present disclosure, the above-described systems can be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in the main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires that comprise bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1300 reads application data and provides an application, information may be read from the application data and stored in a memory device, such as the memory 1304. Additionally, data from the memory 1304 servers accessed via a network, the bus 1308, or the data storage 1306 may be read and loaded into the memory 1304. Although data is described as being found in the memory 1304, it will be understood that data does not have to be stored in the memory 1304 and may be stored in other memory accessible to the processor 1302 or distributed among several media, such as the data storage 1306.

Those skilled in the art will appreciate that the components illustrated in FIGS. 1-13 described above, and in the flow diagram discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

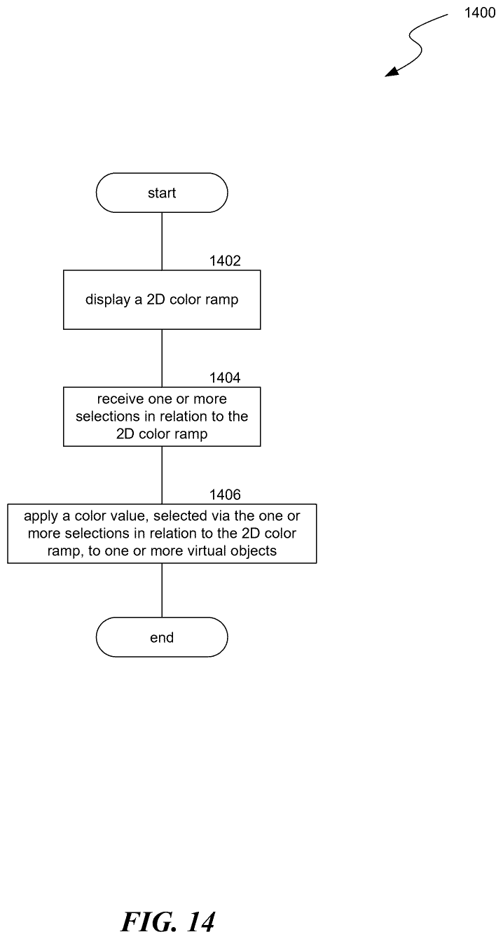

FIG. 14 is a flow diagram illustrating a process 1400 used in some implementations for colorizing a virtual object. In some implementations, process 1400 can be performed on an extended reality system and/or in an extended reality environment.

At block 1402, process 1400 can display a two-dimensional (2D) color ramp. Each of the two axes of the 2D color ramp can define color features along that axis. For example, each axis can define a color gradient. In some implementations, a first axis can define one of: color hues, skin color shades, iris color shades, hair color hues; and a second axis can define parametric input values within each color hue, skin color undertones within each skin color shade, eye color highlights within each iris color shade, hair tones within each hair color hue, etc. In some implementations, the 2D color ramp can be divided into multiple rows or columns, where a first selection selects a particular row or column and a second selection selects a color within that row or column.

At block 1404, process 1400 can receive one or more user selections in relation to the two-dimensional color ramp. In some cases, the one or more user selections can be received via one or more hand gestures or controller gestures, tracked by an extended reality system, in the extended reality environment, e.g., by the user pointing at a point on the 2D color ramp or associated swatches, by dragging virtual slider along the 2D color ramp or a 1D color ramp generated based on a selection in the 2D color ramp, etc.

In some implementations, a first value can be derived from the one or more user selections in relation to a first axis of the 2D color ramp, that specifies a location along the first axis corresponding to multiple color values on a second axis of the 2D color ramp. Then, ether through interpreting the same selection or a second selection in relation to the second axis of the 2D color ramp, a color value can be identified from among the multiple color values corresponding to the first value along the first axis.

In some implementations, a user can make a first selection to select a row or column of the 2D color ramp and then can make a second selection, via a slider control provided on at least the selected row or column. Process 1400 can interpolate the position of the slide control along the selected row or column to determine the color value.

In some implementations, a user can make a first selection to select a source texture or gradient from a corresponding point on the 2D color ramp. Process 1400 can then derive a 1D color ramp based on the selected source texture or gradient, from which the user can select a particular color value. In some cases, deriving the 1D color ramp includes performing a linear interpolation for the 2D color ramp using the portion of the 2D color ramp corresponding to the first selection. In other cases, deriving the 1D color ramp includes slicing the 2D color ramp, along a first axis, at a given height or length, corresponding to the position of the first selection.

In some implementations, the 2D color ramp is divided into multiple sections, and one or more user selections selecting a) a particular section of the multiple sections and b) a color value along the particular section. For example, the user can first select a section and then slide a slider along the selected section or the user can drag a slider that covers all the sections, and which section is selected can be the section corresponding to where the user activates the slider.

In some implementations, a first user selection can select one of multiple displayed color swatches to select a corresponding section of the 2D color ramp and then the user can perform a second selection, along the corresponding section of the 2D color ramp, to select a particular color value.

At block 1404, process 1400 can apply the color value, selected via the one or more user selections in relation to the 2D color ramp, to one or more virtual objects. In various implementations, applying the color value can include using the color value as a basis for shading portions of an avatar, such as the avatar's skin, hair, or eyes, e.g., the color value can be extrapolated to apply variations on the color value to the portion of the avatar. In some implementations, applying the color value can include applying the color value or a variation on it to a virtual object such as clothing, an accessory, etc.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more implementations, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more implementations, the computer-readable media is non-transitory computer-readable media, or non-transitory computer-readable storage media.

In one or more implementations, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the clauses, such term is intended to be inclusive in a manner similar to the term “comprise” as “comprise” is interpreted when employed as a transitional word in a clause.

The word “exemplary” is used herein to mean “serving as an example, instance, or illustration.” Any implementation described herein as “exemplary” is not necessarily to be construed as preferred or advantageous over other implementations. In one aspect, various alternative configurations and operations described herein may be considered to be at least equivalent.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as an implementation may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method clauses may be provided to present elements of the various steps, operations, or processes in a sample order, and are not meant to be limited to the specific order or hierarchy presented.

In one aspect, a method may be an operation, an instruction, or a function and vice versa. In one aspect, a clause may be amended to include some or all of the words (e.g., instructions, operations, functions, or components) recited in other one or more clauses, one or more words, one or more sentences, one or more phrases, one or more paragraphs, and/or one or more clauses.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S. C. § 112, sixth paragraph, unless the element is expressly recited using the phrase “means for” or, in the case of a method clause, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the clauses. In addition, in the Detailed Description, it can be seen that the description provides illustrative examples, and the various features are grouped together in various implementations for the purpose of streamlining the disclosure. This method of disclosure is not to be interpreted as reflecting an intention that the included subject matter requires more features than are expressly recited in any clause. Rather, as the clauses reflect, inventive subject matter lies in less than all features of a single disclosed configuration or operation. The clauses are hereby incorporated into the Detailed Description, with each clause standing on its own to represent separately patentable subject matter.

The clauses are not intended to be limited to the aspects described herein but are to be accorded the full scope consistent with the language of the clauses and to encompass all legal equivalents. Notwithstanding, none of the clauses are intended to embrace subject matter that fails to satisfy the requirement of 35 U.S.C. § 101, 102, or 103, nor should they be interpreted in such a way.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for colorizing one or more virtual objects in an extended reality environment, the method comprising:
displaying a two-dimensional (2D) color ramp, wherein each of two axes, of the 2D color ramp, defines a gradient of color features along that axis;
receiving one or more user selections in relation to the two-dimensional color ramp,
wherein the one or more user selections, in relation to a first axis of the 2D color ramp, specifies a first value along the first axis corresponding to multiple color values on a second axis of the 2D color ramp, and
wherein the one or more user selections, in relation to the second axis of the 2D color ramp, specifies a color value, of the multiple color values corresponding to the first value along the first axis; and
applying the color value, selected via the one or more user selections in relation to the 2D color ramp, to the one or more virtual objects.

2. The method of claim 1,
wherein a first selection, of the one or more user selections, selects a row or column of the 2D color ramp; and
wherein a second selection, of the one or more user selections, is provided via a slider control that interpolates the position of the slide control along the selected row or column, to determine the color value.

3. The method of claim 1,
wherein the one or more virtual objects includes an avatar's skin;
wherein values along the first axis, of the 2D color ramp, define skin color shades with the first value selecting a particular skin color shade;
wherein the multiple color values define skin color undertones, in the particular skin color shade, with the color value selecting a particular skin color undertone; and
wherein the applying the color value to the one or more virtual objects includes applying the particular skin color shade and the particular skin color undertone to the avatar's skin.

4. The method of claim 1,
wherein the one or more virtual objects include an avatar's eyes;
wherein values along the first axis, of the 2D color ramp, define iris color shades with the first value selecting a particular iris color shade;
wherein the multiple color values define eye color highlights, in the particular iris color shade, with the color value selecting a particular eye color highlight; and
wherein the applying the color value to the one or more virtual objects includes applying the particular iris color shade and the particular eye color highlight to the avatar's eyes.

5. The method of claim 1,
wherein the one or more virtual objects include an avatar's hair;
wherein values along the first axis, of the 2D color ramp, define hair color hues with the first value selecting a particular hair color hue;
wherein the multiple color values define hair tones, in the particular hair color hue, with the color value selecting a particular hair tone; and
wherein the applying the color value to the one or more virtual objects includes applying the particular hair color hue and the particular hair tone to the avatar's hair.

6. The method of claim 1,
wherein the one or more user selections include a first selection, for the first value, selecting a source texture or gradient;
wherein the method further includes deriving a one-dimensional (1D) color ramp based on the selected source texture or gradient; and
wherein the one or more user selections include a second selection, in relation to the 1D color ramp, selecting the color value.

7. The method of claim 6, wherein the deriving the one-dimensional (1D) color ramp includes performing a linear interpolation for the 2D color ramp using the selected first value.

8. The method of claim 6, wherein the deriving the 1D color ramp includes slicing the 2D color ramp, at a given height or length, corresponding to the first value along the first axis.

9. The method of claim 1,
wherein the 2D color ramp is divided into multiple sections;
wherein the one or more user selections include a first selection, selecting a particular section, of the multiple sections; and
wherein the one or more user selections include a second selection, in relation to the particular section, selecting the color value.

10. The method of claim 1,
wherein the one or more user selections include a first selection, selecting a particular color swatch corresponding to a section of the 2D color ramp; and
wherein the one or more user selections include a second selection, received via a slider control, selecting the color value within the section of the 2D color ramp.

11. The method of claim 1, wherein the one or more user selections are received via one or more hand gestures, tracked by an extended reality system, in the extended reality environment.

12. A computer-readable storage medium storing instructions, for colorizing one or more virtual objects in an extended reality environment, the instructions, when executed by a computing system, cause the computing system to:
display a two-dimensional (2D) color ramp, wherein each of two axes, of the 2D color ramp, defines color features along that axis;
receive one or more user selections in relation to the two-dimensional color ramp,
wherein the one or more user selections, in relation to a first axis of the 2D color ramp, specifies a first value along the first axis corresponding to multiple color values on a second axis of the 2D color ramp, and
wherein the one or more user selections, in relation to the second axis of the 2D color ramp, specifies a color value, of the multiple color values corresponding to the first value along the first axis; and
apply the color value, selected via the one or more user selections in relation to the 2D color ramp, to the one or more virtual objects.

13. The computer-readable storage medium of claim 12,
wherein a first selection, of the one or more user selections, selects a row or column of the 2D color ramp; and
wherein a second selection, of the one or more user selections, is provided via a slider control that interpolates the position of the slide control along the selected row or column, to determine the color value.

14. The computer-readable storage medium of claim 12,
wherein the one or more virtual objects includes an avatar's skin;
wherein values along the first axis, of the 2D color ramp, define skin color shades with the first value selecting a particular skin color shade;
wherein the multiple color values define skin color undertones, in the particular skin color shade, with the color value selecting a particular skin color undertone; and
wherein the applying the color value to the one or more virtual objects includes applying the particular skin color shade and the particular skin color undertone to the avatar's skin.

15. The computer-readable storage medium of claim 12,
wherein the one or more virtual objects include an avatar's hair;
wherein values along the first axis, of the 2D color ramp, define hair color hues with the first value selecting a particular hair color hue;
wherein the multiple color values define hair tones, in the particular hair color hue, with the color value selecting a particular hair tone; and
wherein the applying the color value to the one or more virtual objects includes applying the particular hair color hue and the particular hair tone to the avatar's hair.

16. The computer-readable storage medium of claim 12,
wherein the one or more user selections include a first selection, for the first value, selecting a source texture or gradient;
wherein the instructions, when executed, further cause the computing system to derive a one-dimensional (1D) color ramp based on the selected source texture or gradient; and
wherein the one or more user selections include a second selection, in relation to the 1D color ramp, selecting the color value.

17. The computer-readable storage medium of claim 16, wherein the deriving the 1D color ramp includes slicing the 2D color ramp, at a given height or length, corresponding to the first value along the first axis.

18. A computing system for colorizing one or more virtual objects, the computing system comprising:
one or more processors; and
one or more memories storing instructions that, when executed by at least one of the one or more processors, cause the computing system to:
display a two-dimensional (2D) color ramp, wherein each of two axes, of the 2D color ramp, defines color features along that axis;
receive one or more user selections in relation to the two-dimensional color ramp,
wherein the one or more user selections, in relation to a first axis of the 2D color ramp, specifies a first value along the first axis corresponding to multiple color values on a second axis of the 2D color ramp, and
wherein the one or more user selections, in relation to the second axis of the 2D color ramp, specifies a color value, of the multiple color values corresponding to the first value along the first axis; and
apply the color value, selected via the one or more user selections in relation to the 2D color ramp, to the one or more virtual objects.

19. The computing system of claim 18,
wherein the 2D color ramp is divided into multiple sections;
wherein the one or more user selections include a first selection, selecting a particular section, of the multiple sections; and
wherein the one or more user selections include a second selection, in relation to the particular section, selecting the color value.

20. The computing system of claim 18,
wherein the one or more user selections include a first selection, selecting a particular color swatch corresponding to a section of the 2D color ramp; and
wherein the one or more user selections include a second selection, received via a slider control, selecting the color value within the section of the 2D color ramp.
